(19) United States
(12) Patent Application Publication
(10) Pub. No.: US 2005/0222846 A1
(43) Pub. Date: Oct. 6, 2005

(54) Character branding employing voice and speech recognition technology

(76) Inventor: Christopher Tomes, Chicago, IL (US)

Correspondence Address: MCGUIREWOODS, LLP, 1750 TYSONS BLVD, SUITE 1800, MCLEAN, VA, 22102, US

(21) Appl. No.: 11/140,976

(22) Filed: Jun. 1, 2005

Related U.S. Application Data
(63) Continuation-in-part of application No. 10/712,973, filed on Nov. 12, 2003.
(60) Provisional application No. 60/425,428, filed on Nov. 12, 2002.
(60) Provisional application No. 60/575,386, filed on Jun. 1, 2004.
(60) Provisional application No. 60/607,348, filed on Sep. 7, 2004.

(51) Int. Cl. H04M 11/00

(52) U.S. Cl. 704/275

(57) ABSTRACT

Devices, apparatuses, systems, methods and the like for marketing, promoting and/or advertising a business or product are provided. The present invention combines applications such as screen savers, desktop assistants and instruction with voice verification technology in a readily installable and operable computer form. The voice interactive applications include visual imagery to attract a user/customer(s) to activate and interact with the application. Once activated, the application prompts the consumer user for voice input. The voice input, once authenticated, can then be processed to interact with a product character to perform tasks such as connecting the consumer user to a web-site associated with the advertised business via a hyperlink. Interaction with the product character in a variety of voice interactive applications provides the consumer user with ready and easy access to further product information, product purchasing capabilities, business contact information, updates on promotional products, and/or the like to facilitate the marketing, promoting and/or advertising of the business.

### CROSS REFERENCE TO RELATED APPLICATIONS

This application claims priority under 35 U.S.C. §120 as a continuation-in-part of U.S. patent Application Ser. No. 10/712,973, filed on Nov. 12, 2003, which claims priority to U.S. Provisional Application No. 60/425,428 filed Nov. 12, 2002, the disclosures of which are all expressly incorporated by reference herein in their entirety. This application also claims priority under 35 U.S.C. §119(c) to U.S. Provisional Patent Application Nos. 60/575,386, filed on Jun. 2, 2004 and 60/607,348, filed on Sep. 7, 2004, the disclosures of which are all expressly incorporated by reference in their entirety

### FIELD OF THE INVENTION

The present invention relates to marketing, promoting and/or advertising a business, brand, and/or a product. More specifically, the present invention relates to devices, apparatuses, systems and methods for marketing, promoting and/or advertising a business, brand and/or product through voice and speech verification and recognition technology used in connection with a branded character.

### RELATED ART

Businesses market products to consumers by using symbols or other visual indicia to represent the business and its products. These symbols or indicia serve as trademarks, brands, and/or logos which consumers use to identify a business or product. In many cases, such symbols or indicia include branded characters, also referred to as product characters, such as animations or spokespersons, which are identified with the business and/or its products. For example, the well-known clown, Ronald McDonald™, represents the hamburger franchise, McDonalds™, and its products. In other cases, the branded character may itself be the product. For example, the character Spider-man™, of Marvel Comics™, is the product in the form of comic books, movies, action figures and the like. Generally, a business attempts to create recognition among its target consumer population of the business brand and/or product character to distinguish its products from other products in the market and to create an expectation of quality associated with the business or product. Additionally, product characters are used to attach a personality to the product for the purpose of translating consumer familiarity with and appreciation of the product character into consumer familiarity with and appreciation of the product itself.

In a seemingly unrelated field, voice or speech recognition technology has been used in applications in the form of biometric identification to identify a user, converting speech or sound to text, and controlling digital functions within software applications. Speech recognition technology has been utilized in lieu of passwords, pre-programmed letters and/or number combinations, or other forms of imitatable identification. Speech recognition technology has been utilized to allow a user to input and text through voice commands into computers or other devices. Voice commands are typically processed to convert the sound to text to enable the creation of documents, e-mail messages, or other written applications without the use of input from a keyboard. The voice command can also be used, in general, to control computer-related applications such as automated telephone answering systems to route calls through a selection menu to a proper destination.

Until now, voice or speech recognition technology has not been integrated with marketing techniques to provide verbally interactive marketing campaigns wherein consumers can establish one-to-one “relationships” with product spokespersons or animated characters. A need, therefore, exists to provide and combine the capabilities of speech or voice recognition-related technologies for business marketing, promotional and/or advertising purposes.

### SUMMARY OF THE INVENTION

The present invention provides improved devices, apparatuses, systems, and methods for marketing, promoting, and/or advertising a business or the like. In particular, the present invention employs an interactive presentation based on a marketing theme or promotion which responds to and/or is activated by the recognition of the voice of a consumer user and controlled by speech recognition of verbal commands entered by the consumer user. This interactive promotional software can provide a promotional presentation and/or can be incorporated into any operating system, application or electronic device to provide the consumer user voice interactive functionality within the context of a business promotional theme or environment in connection with a branded character.

Voice verification of a previously recorded and stored voice input by the consumer user allows the present invention to provide a promotional presentation customized to the individual consumer user in connection with a branded character. The promotional presentation may include a text display, a movie or animation clip, and/or other like visual imagery to provide an audio, video or multi-media presentation to the consumer user. In addition, the interactive promotional software may be adapted to activate a hyperlink via the Internet which directs the consumer user to a web-site associated with the business for the promotional presentation and/or for conducting business-related activities. Business activities may include reviewing product and/or service information, purchasing same, and/or the like.

One or more brand visuals, logos, branded or product characters or the like associated with a business or product may be used to facilitate the business marketing, promotional and/or advertising presentation. Additionally, the branded or product character associated with the promoted product or business can encourage the interaction of the consumer user with the software. The product character, for example, can interact with the consumer user to perform tasks in a computer-operating environment and other media-delivering electronic devices, such as televisions, personal digital assistants (PDA) and cell phones, in response to the recognized voice commands of the consumer user.

In an aspect of the invention, the interactive promotional software combines voice and speech recognition technology with software applications to form voice interactive applications which combine the finctionality of the voice interactive application with the business marketing, promotional and/or advertising presentation. Voice interactive applications may utilize a product character to perform any one of a series of predetermined tasks in response to the recognized voice commands of the consumer user. For example, in an interactive application which combines screen saver and voice verification technology, the screen saver presents a text display, a movie or animation clip, and/or other like visual imagery to provide a multi-media marketing, promotion and/or advertising presentation. The multi-media presentation becomes active whenever a typical screensaver display is normally displayed. The multi-media presentation may include an interactive product character to interact with the consumer user. Further, the product character can interact with the consumer user to suspend the screen saver mode and to transition the consumer user to a web-site of the advertising business. The branded or product character may serve as an office or desktop assistant, or any other functionality provided in an operating system environment, software applications, or device electronics. The product character may also be utilized in a promotional game wherein interactions between the product character and the consumer user advance the course of the game.

Speech recognition capabilities allow the branded character to interact with the recognized voice commands of the consumer user. Via this mechanism, the product character provides promotional instruction in the form of an educational lesson or other interactive activity between the product character and the consumer or user. Similarly, the product character is used in one embodiment to present product information or tutorials. It should be appreciated that the product information can include any information about the product such as background information, general operating instructions, specific uses of the product, advantages of the product, technical specifications or any other information the advertising business desires to provide to the consumer or user.

In another aspect of the invention, a computer program is stored on a medium adapted to be read by a computer processing device which operates a voice interactive application for business promotion. The computer program includes computer readable code for the voice interactive application, computer readable code for executing a plurality of commands to activate the voice interactive application, and computer readable code for running the voice interactive application.

In another aspect of the invention, an apparatus for business promotion is provided. The apparatus includes a device adapted to operate a voice interactive application. The apparatus can be employed within a system for business promotion.

A novel method for business promotion is also provided. The method includes the steps of providing a device adapted to operate a voice interactive application wherein the device is capable of prompting, receiving and processing voice input. Voice commands are input into the device and activate the voice interactive application. Voice commands are based on the content of the speech as well as the identity of the speaker.

Additional features, advantages and embodiments of the invention may be set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF THE FIGURES

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practices. In the drawings:

FIG. 1 illustrates a set-up flowchart of a voice interactive application according to an embodiment of the invention;

FIG. 2 illustrates an operational flowchart of a voice interactive application according to an embodiment of the invention;

FIG. 3 illustrates an editing console flowchart of a voice interactive application according to an embodiment of the invention;

FIG. 4 illustrates a product character interacting with a consumer user to perform a software-related task according to an embodiment of the invention;

FIG. 5 is an operational flowchart of a voice interactive application facilitating communication between a user and a recipient according to an embodiment of the invention;

FIG. 6 illustrates a schematic for a voice interactive instant messaging system according to an embodiment of the invention;

FIG. 7 illustrates a microphone device for a voice interactive instant messaging system according to an embodiment of the invention; and

FIG. 8 is a flowchart illustrating a speech activated voice and video instant messaging service according to an embodiment of the invention.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

The invention generally relates to employing voice and speech recognition technology in interactive promotional software to enhance the marketing, promoting and/or advertising efforts of a business. In particular, the present invention relates to devices, apparatuses, systems and methods for providing customer interactive marketing and/or advertising campaigns through voice verification and speech recognition technology. The invention can be configured in a number of suitable and desirable ways to provide an overall multi-media and product promotion that employs voice input, voice activation and synthesized voice interaction in order to capture the attention of its consumer users of all ages and promote brand awareness and loyalty.

The interactive promotional software can include both voice and speech recognition technologies. Voice recognition technology is used by the invention for activation of the interactive promotional software and for identification of the consumer user to provide a presentation customized to the individual consumer user. Speech recognition technology is applied in the invention in voice interactive applications which allow the consumer user to interact verbally with interactive applications incorporating a marketing and/or advertising theme. The speech recognition technology and the voice interactive applications provide a unique combination of functionality for improved business marketing, promotional and/or advertising purposes.

The interactive promotional software includes visual imagery conveying marketing, promotional and/or advertising information related to the business. The interactive promotional software can further include a multi-media presentation based on the marketing theme or promotion through audio and visual effects controlled by the recognition of the voice of the consumer user. The audio-visual effects can include three-dimensional animation as well as full motion virtual multi-media. It should be appreciated that the interactive promotional software can utilize other visual images such as text, animation, movie clips and/or the like to capture the attention of the consumer user and encourage interaction. The visual images can include, for example, dynamic images, such as a brand visual, logo, product character, and/or any other suitable manner of identifying the business or the product.

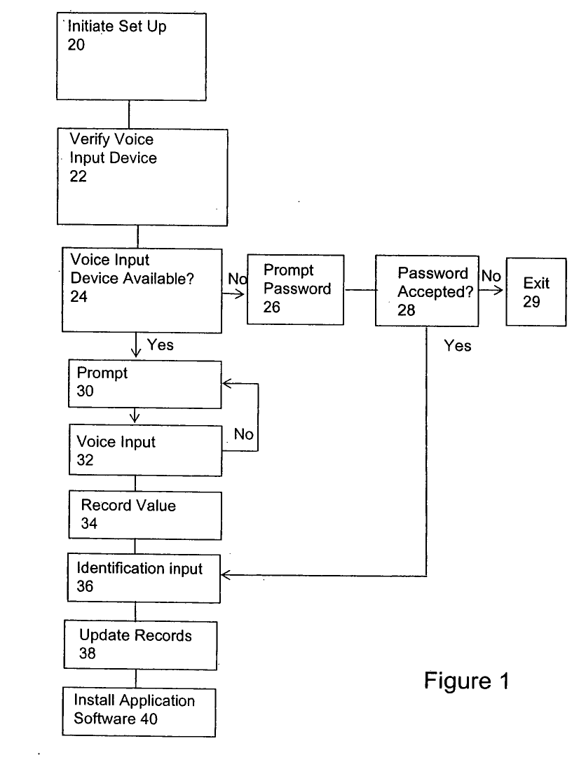

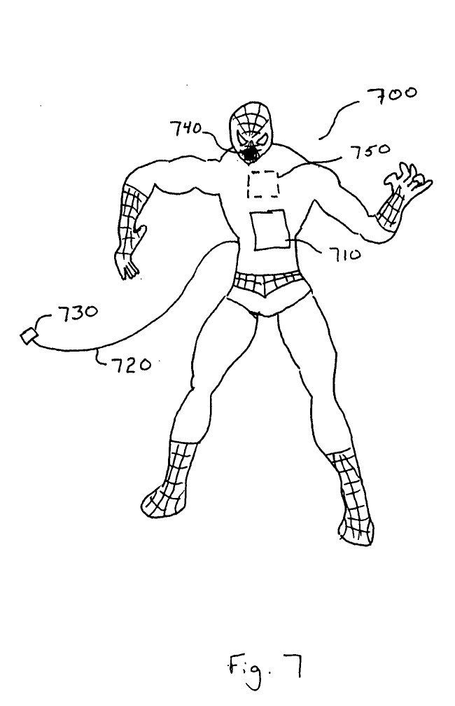

In an embodiment, the interactive promotional software is interfaced with voice recognition technology to provide a promotional experience customized to the consumer user and/or to interact with the consumer user in a personalized manner in the operation of an associated application. FIG. 1 illustrates a flow diagram describing the set-up of a voice interactive application according to an embodiment of the invention. As illustrated in step 20, a set-up program is initiated to enable the consumer user to prepare the voice recognition feature of the application for future voice input by the consumer user. The program first checks for the presence of an input device such as a microphone or any suitable sound detection device, as illustrated in steps 22 and 24. An example of one such microphone is set forth in FIG. 7 below. If no input device is detected or confirmed by the consumer user, the program provides the consumer user with the opportunity to enter a password instead of a voice input, as illustrated in steps 26 and 28. If the consumer user enters a password, the password is stored for later comparison to a password input, as illustrated in step 32. Otherwise, the consumer user exits the set-up program, as illustrated in step 38. If an input device is detected or confirmed by the consumer user, the voice interactive application prompts the consumer user to make a unique entry or input such as a voice or any other suitable sound through the user interface, such as a microphone, as illustrated in step 29. The user interface is operably connected to software which digitally records the input of the consumer user, as illustrated in steps 32 and 34, and stores the sound electronically, as illustrated in step 36. Unique characteristics of the voice entry are processed by voice verification software for comparison to subsequent sound entries to identify the consumer user and match commands and responses made by the consumer user in subsequent prompts by the software. Once the voice input or password input has been stored, the consumer user is enabled to save preferences specific to the operation of the application as illustrated in step 38. At this point, the application is prepared for installation as illustrated in step 40.

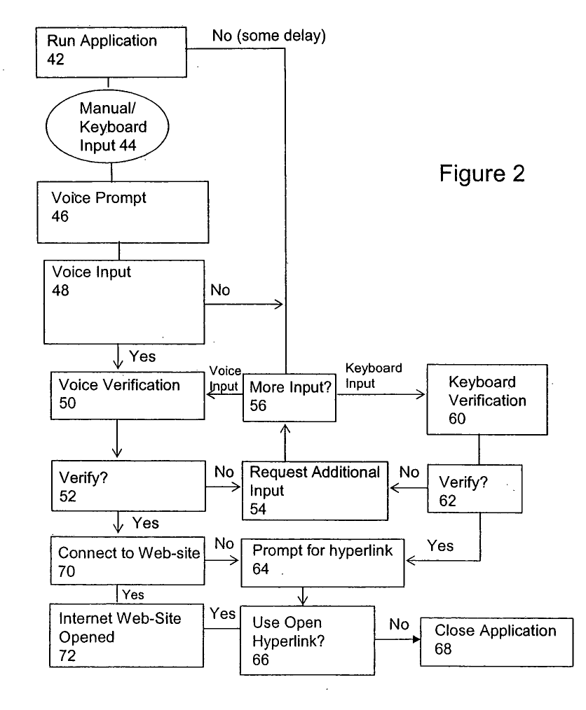

A voice command of the consumer user subsequently input and recognized by the interactive promotional software can activate the interactive promotional software. FIG. 2 illustrates an example of an interactive process with a voice interactive application through verbal commands to control and to otherwise interact with a visual component of the application. The steps can include initiating the application, as illustrated in step 42. An input by the consumer user through a mouse or keyboard input, as illustrated in step 44, triggers a text message, voice message and/or the like. As illustrated in step 46, the text message, voice message or the like triggered in step 44 prompts the consumer user to provide the pre-recorded voice input from the set up process illustrated in FIG. 1. The voice input of the consumer user can be provided via a voice input device, such as a microphone or the like. Alternate user verification methods may also be employed. The voice input or other verification data is then processed and compared to the pre-recorded input described in FIG. 1 with the voice verification technology at step 50 after input is detected at step 48. If the voice input or other data is authenticated, the consumer user may be prompted again for another voice input, as illustrated in step 52. If no match to the voice input occurs, the application may require additional input including additional voice input, as illustrated in steps 56, 60, and 62. However, the present invention can be modified to allow the consumer user to bypass the voice activation mode, thus allowing the consumer user access via keyboard or other suitable input device as illustrated in steps 56, 58, 60, and 62.

Once the consumer user has been identified, a promotional presentation customized to that user and/or a promotional theme combined with functionality of a voice interactive application is activated and provided to the consumer user. As illustrated in step 64 of FIG. 2, the consumer user is asked if he or she would like to be connected via hyperlink to a web-site related to the advertised business.

If the consumer user provides a recognized voice command in the affirmative, as illustrated in step 66, the consumer user is connected to the hyperlinked web-site, as illustrated in step 72. Otherwise, if the consumer user provides a recognized voice command in the negative, the application can close, as illustrated in step 68. It should be appreciated that the present invention can be configured to directly connect the consumer user to the web-site via an automatic hyperlink upon voice authentication, as illustrated in step 70. This can be done without the use of the keyboard, thus facilitating use of same. It should be also appreciated that the interaction with the computer user can include the product character or other visual component thereby further incorporating the promotional theme within the function of the application.

Once the consumer user gains access to the business web-site through voice authentication or password in the example illustrated in FIG. 2, the interactive promotional presentation may be presented to the consumer user via the internet or other network. In addition, the web-site can include product information, product-purchasing capabilities, business contact information, update promotions, new and updated applications which are downloadable and/or the like.

In one embodiment, the web-site may be configured to provide the consumer user with the ability to order a product through additional voice input. The ordered product can also be sent as a gift to another party. In this case, the consumer user may be able to send a message along with the gift. The message can be entered by voice input and can generate a print message to be delivered with the gift and/or can generate a message to be sent via email. If sent electronically, the message can also include promotional products or downloadable access to promotional products from the company. For example, the message may be sent along with a promotional screen saver application that displays a calendar. The consumer user can use the calendar to input a person(s) and date(s) upon which time a gift can be sent to that person. In this regard, the calendar acts as a reminder to prompt the consumer user to purchase products which may or may not be associated with the advertising business, such as flowers, that can be sent as gifts to friends and/or family.

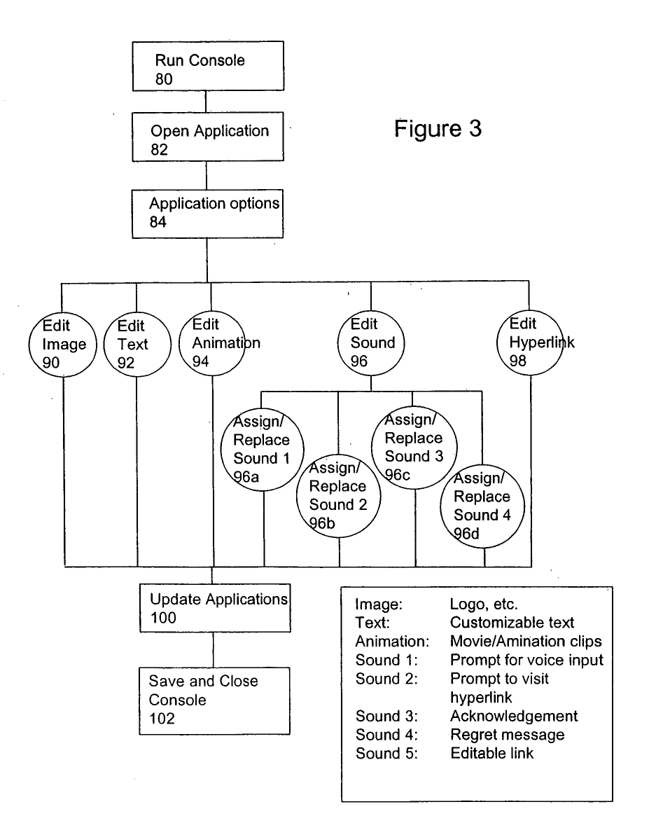

As illustrated in FIG. 3, the voice interactive applications of the present invention can be edited and/or modified according to the preferences of the consumer user identified by the voice verification technology. In this regard, the present invention can be readily customized to meet the specific needs of the business in order to facilitate consumer user interaction with the voice interactive application. FIG. 3 illustrates an example of an editing console used in an embodiment of the present invention in which the consumer user is connected via hyperlink to a web-site. As illustrated in steps 80 and 82, upon running the editing console, the application is opened to provide a menu of preferences to be customized by the consumer user, as illustrated in step 84. It should be appreciated that the preferences provided to the consumer user will vary with each application. Examples of application options which can be edited and modified by the consumer user include images, logos, product characters, or any other visual component, as illustrated in component 90; text, as illustrated in component 92; animation or movie clips, as illustrated in component 94; sound files, as illustrated in component 96; or one or more hyperlinks, as illustrated in component 98. As illustrated in components 96a, 96b, 96c and 96d, the sound files, such as prompting for voice input, prompting to visit a hyperlink, acknowledgment and regret messages, can be assigned and/or replaced. Once the voice interactive activation options are updated, the console can close as illustrated in steps 100 and 102, respectively.

Additionally, the interactive promotional software can be edited, modified and/or updated through a web link. It should be appreciated that the update can be performed automatically upon establishment of a web link or can be in the form of a prompt to the consumer user to update the existing software. The present invention contemplates, for instance, updating features, such as refinements to the voice recognition features, along with updates to the promotional and marketing materials incorporated in the software application.

Each embodiment of the present invention may include a visual component associated with the promoted business or product which is adapted to interact with the computer user. Interactive visual components may include dynamic images, such as a brand visual, logo, product character, and/or any other suitable means of identifying the business or the product.

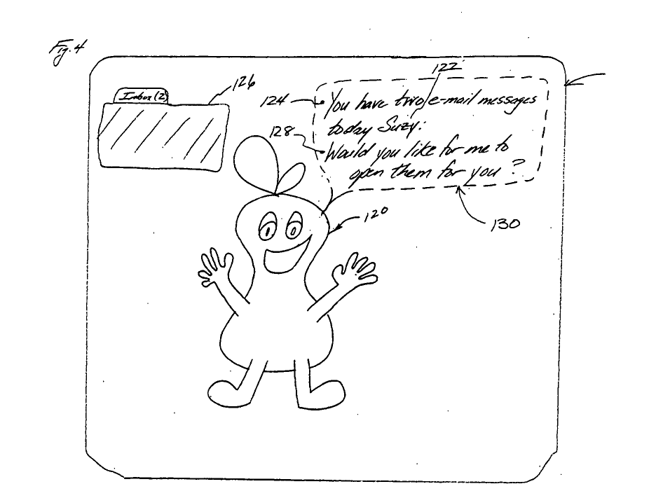

For example, the product character, or animated trademark or company logo can be adapted to work with the application software to provide information related to the application, to personally address the consumer user when providing information, and/or to make any inquiries through audio and visual interaction. One embodiment of the present invention includes a product character which, in response to a sound input which matches a previously stored input, performs any one of a series of predetermined tasks. The predetermined tasks are programmed to be initiated by the product character or in response to the recognized voice command of the consumer user. The product character interacts with the consumer user by seeking input from the consumer user and by prompting the consumer to provide a voice input. FIG. 4 illustrates an example of the interaction of a product character 120 with a consumer user. As illustrated in FIG. 4, the product character 120 can refer to the consumer user by name, e.g., “Suzy,” 122 based on the voice verification of Suzy as the consumer user. Additionally, the product character can serve as a functional component in the voice interactive application. For example, a product character, trademark, corporate logo or other animated visual component may be incorporated into an application for managing e-mail. When the user receives an e-mail message, a mailbox icon 126 is displayed. The product character 120 in FIG. 4, for example, can inform the consumer user that he or she has unread mail and the number of unread messages in her e-mail inbox. This information is communicated verbally by the product character as indicated by the speech bubble 130 in FIG. 4. For example, in FIG. 4, the character informs the user that she has email at 124. Subsequently, the product character 120 can offer to perform a task for the consumer user such as opening or displaying the new messages as shown at 128 based on the speech recognition of the voice command provided by the consumer user. It should be appreciated that the interactive communication 130 can be in audio form, wherein a synthesized voice is associated with the product character which can become recognizable to the consumer user after multiple interactions. Alternatively, the interactive communication 130 of the product character can be visual using a text message or other visual form of communication. Moreover, the interactive communication 130 can be both audio and visual.

The product character may further be used in other voice interactive applications such as a desktop assistant which is enabled to perform operating system-related tasks, such as opening, saving and re-opening documents and other files, launching and closing application programs, and the like, in response to recognized voice commands of the consumer user. The response may include an audio, a video, a pictorial or text response or some combination thereof from the product character depending on the circumstances as well as the execution of the desired commands. The product character, for example, may provide an audio response to the command such as “Coming right up”, or the product character may provide an audio follow-up question such as “From what day would you like to view your e-mail?”

According to an exemplary embodiment of the invention, an Instant Messaging (“IM”) system may be implemented based on speaker verification, speech recognition, and branded characters described in connection with the invention. For example, as IM is popular with elementary school children, among others, the branded character may be animated cartoon characters. A system uses speaker verification to authenticate the user instead of the traditional user identification and password combination. Speech recognition is utilized to allow the user to activate the IM window using voice commands instead of other interaction, such as a keyboard, mouse clicks and the like. Speech recognition may also be utilized to perform certain operations in IM. A rectangular two-pane window commonly used by many IM solutions may be replaced by a user interface consisting of a branded character. According to an embodiment of the invention, the user-interface may be flash based. The branded character may be animated, such as Spider-Man™, Bugs Bunny, etc. that will interact with the user. Alternatively, the branded character may be an animated or graphic representation of a real-person, such as an athlete, movie star, etc. The use of an animated character may improve the user experience by allowing for personalization and may also provide an opportunity for brand marketing. The user may record a message, such as up to a certain maximum duration, and have that message delivered to the desired recipient via the animated character.

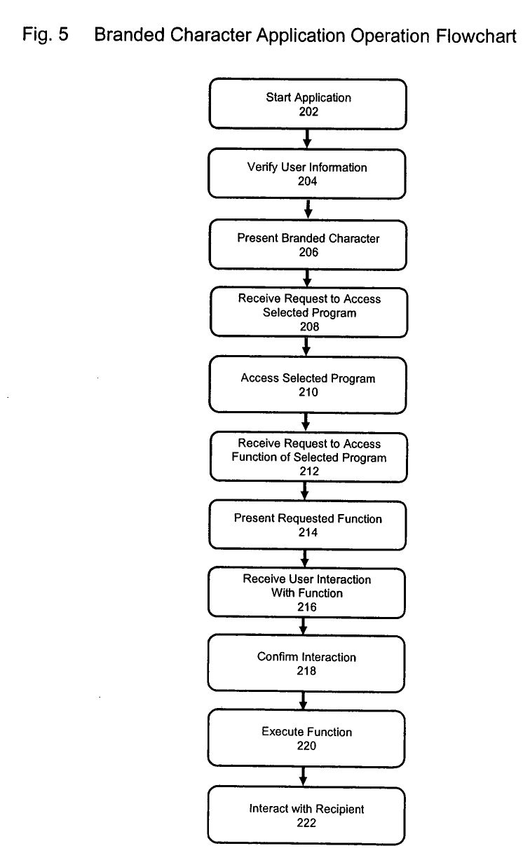

FIG. 5 illustrates an operational flowchart of a voice interactive application facilitating communication between a consumer user and a recipient according to an embodiment of the invention. At step 202, a voice interactive application is started, and user information is verified at step 204. A branded character is presented at 206, and receives a request to access a selected program at step 208. At step 210, the requested selected program is accessed. At step 212, a request to interact with functions of the selected program is received, and the requested function is presented at step 214. User interaction with the function is received at step 216 and confirmed at step 218. At step 220, the function is executed. At step 222, interaction with the recipient occurs. The process in the flowchart of FIG. 5 will now be described in greater detail below. This description will include reference to a specific embodiment involving one type of application (instant messaging, or “IM”) on a personal computer. However, it is understood that other applications may be used in other environments consistent with the disclosure and various embodiments described herewith.

At step 202, a voice interactive application is started. Starting a voice interactive application may occur when a user first turns on the computer and logs on. By way of an example, the voice interactive application may be in the start menu of a personal computer, such that it automatically runs when the personal computer is first started. Alternatively, starting a voice interactive application may be performed by a user activating the voice interactive application, such as by using a mouse and double-clicking an icon associated with the voice interactive application. According to an exemplary embodiment of the invention, a user may speak to activate the voice interactive application. By way of example only, a user may have a voice interactive application that uses Spider-man™. To activate the application, the user may ask Spider-man™ for assistance.

User information is verified at step 204. Verifying user information may involve any form of verification, such as requiring and verifying a user identification indicator and a password. According to an exemplary embodiment of the invention, verification of user information may be performed by receiving a spoken password from the user, and, based on both the actual password as well as the speech recognition, verifying the identity of the user and any privileges (e.g., applications and data available to a user, the ability to save, modify and/or read particular files, etc.).associated with that user. In the example above of a voice interactive application (also referred to as a branded character voice interactive application or a branded character application) with Spider-man™, the verification may occur based on the speech recognition of the user.

By way of another exemplary embodiment of the invention, two or more users of a particular personal computer each may have their own individual voice interactive applications resident on the personal computer. For example, on a family computer, an application with Spider-man™ is used by a teenage user, an application with a pro-football player is used by the father, an application with a movie star is used by the mother, and an application with a cartoon character is used by a five-year old child. A user, such at the teenager, speaks and requests that the voice interactive application run, such as, for example, by requesting assistance from Spider-man™. The voice of the user is analyzed and based on the speech recognition and information contained with the request, the appropriate voice interactive application is activated. Thus, if an unauthorized user requests an application (i.e. the five-year old child attempts to activate the Spider-man™ voice interactive application), the request is denied based on the voice of the unauthorized user not matching the voice of the appropriate user. Other manners of verifying user information may also be used.

A branded character is presented on at step 206. This presentation may occur based on the branded character. In the example described above, where Spider-man™ is associated with the application, a Spider-man™ graphic may appear on the screen, such as by shooting a web from off-screen, then swinging onto the screen and then hanging from the web. Spider-man™ may then interact with the user, such as by asking, via a text and/or audio message, what assistance the user desires. The text and/or audio message may include using the user's name. The presentation may vary, based on the characteristics of the branded character. The current example has Spider-man™ using a web. Other examples may include, but are not limited to, a basketball player taking a shot, a train moving on tracks, and a television star playing a part.

The branded character receives a request to access a selected program at step 208. Selected program may include the internet, email, word processing, a spreadsheet, a game or any other type of program. According to an exemplary embodiment, the other application may be any application that can be resident on a personal computer. By way of the example above, a user may request that Spider-man™ access an instant messaging (IM) application.

At step 210, the selected program is accessed. The voice interactive application of the invention may activate and access the selected program, and may make this selected program available for use. By way of the example above, the graphic of Spider-man™ moves to the instant messaging icon and activates it. This may include opening the IM graphic user interface for display to the user, displaying features of the instant messenger application for the user, and displaying waiting messages to the user. According to an embodiment of the invention, the manner of accessing the selected program may vary based on the features and type of the selected program being requested.

At step 212, a request to access a function of the selected program is received. Through the application of the present invention, a user may request to interact with one or more particular functions in the selected program. By way of the example above, a user may request, through the Spider-man™ application, that an instant message be sent to a friend. Other functions may also be accessed, such as addresses, received messages and the like. For example, email messages (in an email application), spreadsheet data (in a spreadsheet function), and a document (in a word processing application) may be accessed. Other functions, based on the selected program accessed, may also be accessed.

The requested function is presented at step 214. The branded character may interact with the application associated with the function to present the function to the user. By way of the example described above, the Spider-man™ graphic may move, such as by shooting a web and moving along it toward the portion of the IM graphic user interface associated with sending a message, and may activate (e.g. depresses a soft button) the function. In this example, activating the feature may include providing a window and/or area for text associated with the message. In an alternative embodiment of the invention described above, Spider-man™ may shoot his web toward the user, where the web morphs into a window for creating a message. Presenting a function may vary based on the application from where the function originates as well as the character associated with the voice interactive application.

User interaction with the function is received at step 216. The branded character application may assist the user in interacting with a function of the selected program. By way of the example described above, Spider-man™ may assist in creating a message to be sent via an IM. According to an exemplary embodiment of the invention, a user dictates, through a microphone and/or moving picture input (e.g., camera) connected to the personal computer, a message to the branded character application. The message may include the substance of the message, the name of the recipient and the format, such as text, audio or wave file, video file, or a combination thereof. In receiving the message, the branded character application may record a voice and/or video message from the user to be replayed to the recipient. Alternatively, the branded character voice interactive application may transcribe a voice and/or video message from the user to present as text to the recipient. Further, the branded character application may transcribe or record a voice and/or video message from the user to be spoken by the branded character to the recipient. In addition, some combination may be performed (e.g., combining text with a replayed sound file). Thus, in the example described above, Spider-man™ receives the spoken message of the user and prepares it for transmitting to the recipient.

The interaction of the user with the selected function is confirmed at step 218. Confirmation may be performed by presenting the interaction to the user and providing the opportunity to edit or delete the interaction. By way of the example described above, the message received from the user for the instant messaging may be displayed and/or played for the user to confirm the contents, confirm the intended recipient and other confirmation.

At step 220, the function is executed. The branded character application may execute the function after the user has confirmed the contents. The execution may involve executing the function of the selected program in its normal mode. Alternatively, the branded character voice interactive application may act with the selected program to execute the function. For example, where Spider-man™ is the branded character, Spider-man™ may shoot a web that takes away the message for the instant messaging.

Interaction with the recipient occurs at step 222. The branded character application of the user may appear at the location of the recipient to assist. In the example described above, Spider-man™ appears on the screen of the personal computer of the recipient to announce that an instant message has been received from the user, and to query whether the recipient wants to access the instant message. The recipient has the option to access the instant message, or to wait until a later time, or to delete the instant message.

When the recipient elects to access the instant message, the branded character voice interactive application presents the message, such as by displaying text, replaying the audio and/or visual message, and/or speaking the message to the recipient. The branded character application presenting the instant message may be a branded character application already resident at the recipient (e.g., resident on the recipient's personal computer). Alternatively, the branded character application may be the same branded character application used by the user who sent the instant message. Such an embodiment may be useful from a “viral marketing” standpoint, as computer users may be exposed to new applications. In the exemplary embodiment described above, Spider-man™ may enter the screen of the recipient and display the instant message.

While the flowchart above has been described with reference to certain steps in one particular order, it is understood that additional steps may be added, steps may be deleted and/or steps may be taken in a different order without departing from the invention. Rather, this flowchart is an exemplary illustration of an embodiment of the invention.

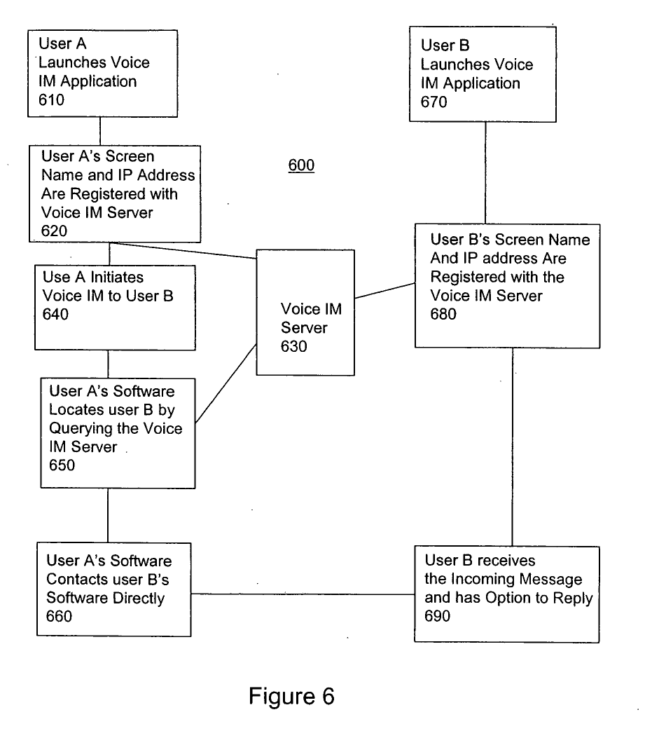

FIG. 6 illustrates an information flow schematic 600 for a voice interactive instant messaging system according to an embodiment of the invention. The user experience may start by the user launching the voice interactive IM application, as shown in 610. Launching the voice interactive IM application may occur using any conventional manner, such as via a mouse click. It is also possible that the user with a voice interactive desktop assistant will be able to launch an instance using a voice command. Upon launch, the user's screen name and address, such as an IP address, are registered at 620, with the voice IM server 630. When the voice interactive application is launched, a branded character will appear and initiate a conversation with the user. The user can then choose to start a text-based chat session with a friend or may choose to send an instant voice message to the friend at 640. If the friend is offline, the user may have a choice of saving the voice message for later delivery. Messages may be retained for a preset duration of time for delivery and may be discarded thereafter. Depending on the users preferences, the animated characters may deliver advertising content to the user.

The voice interactive IM application locates the recipient by sending, at 650, a query to the voice IM server 630. Upon locating the recipient, the voice interactive IM application contacts the recipient directly at 660.

As some point in time, the recipient launches the voice interactive IM application at 670. Upon launch, the recipient's screen name and address, such as an IP address, are registered at 680, with the voice IM server 630. When the user's voice interactive IM application contacts the recipient directly at 660, the recipient receives the incoming message at 690 and has various options, including listening to the message, replying, deleting the message, saving the message, or other options.

An example of a sequence interaction with a voice interactive instant messaging application is now provided below, with spoken words in quotes, and actions otherwise described.
User: “Hey Spidey:”
Spider-man™ appears: “How can I help you?”
User: “Voice message.”
Spider-man™: “To who?”
User: enters name, either through a keyboard or by speaking.
Spider-man™: “I am ready.”
User: “Hey Dave, don't forget we have baseball practice tonight at six.” User stops talking.
Spider-man™: “Got it, do you want me to send it?”
Recipient: “Yes.”
Spider-man™: Sends Voice IM, appears on other users screen and says: “You have a voice IM from [user's name], would you like to hear it now ?”
User: “Yes.”
Spider-man™: plays the Voice IM.

It is understood that the sequence above is merely exemplary, and that other instructions, dialogue, configurations and sequences may also be used.

Some personal computers may not be equipped with a microphone for a user to interact with a branded character application. Therefore, it may be necessary to provide such a microphone to enable a user to interact with a branded character voice interactive application using voice and speech recognition. According to an exemplary embodiment of the invention, a microphone device is provided for a user to access and interact with a branded character application. The microphone device may be provided to the user in the shape of a desired branded character, where the branded character of the microphone is the same as the branded character of the branded character voice interactive application. The user may then use the microphone to interact with the branded character application.

FIG. 7 illustrates a microphone device for a voice interactive instant messaging system according to an embodiment of the invention. The microphone device 700 is shown in the shape of Spider-man™. However, it is understood that the microphone device 700 may be any branded character that is desirable for a user. Microphone device 700 has a microphone 710 for receiving speech instructions from a user. A cord 720 is connected to the microphone 710 through the body of microphone device 700. The cord 720 has an interface 730 for connecting to a personal computer (not shown). Interface 730 is shown as a plug, but it is understood that it may be any device that allows the microphone device 700 to connect to a computer, such as, but not limited to, a cable connection and a wireless transmitter (e.g., such as one using WiFi, or the like).

Further, microphone device 700 may also include a speaker 740. It is understood that microphone 710 may also perform the function of speaker 740. In addition, as speakers may be found in a standard personal computer, it is understood that microphone device 700 may be provided without speaker 740.

Using microphone device 700, a user may speak commands to interact with a branded character application described above. To promote the use of the branded character application, microphone device 700 may be distributed with the branded character application. By way of example only, a branded character application may be stored on a medium, such as a compact disc or DVD, and distributed to users, such as sold at stores. The medium may also have included with it the microphone device 700 to ensure that the user may use all the features of the application, including speech and voice recognition. By way of another example, the branded character application and the microphone device 700 may be given away, such as in a prize in a food package (e.g., in a box of cereal, with a fast food purchase, etc.) or sent to user after a user redeems the application and microphone device (e.g. sends in the requisite proof of purchase of a particular product). The user may then install the microphone device 700 and interface with it to activate and interact with the branded character application.

According to an embodiment of the invention, microphone device 700 may contain a storage medium 750 that includes software code for the appropriate branded character application. Upon installing the microphone device, such as plugging the connection 730 into a personal computer (not shown), the software code on the storage medium may be loaded onto the personal computer to enable the user to use the microphone device 700 to interface with the branded character application. Loading the software code may be achieved through any known manner, such as by activating a feature in the personal computer for downloading and installing the software code. Alternatively, the microphone device 700 may include a “plug and play”feature, where the software code is loaded and installed on the personal computer automatically when the microphone device 700 is plugged into the personal computer. Thus, a user connects the interface 730 of microphone device 700 to the personal computer, and the software code is automatically loaded.

In one embodiment of the invention, the software code in storage medium 750 is the entire software code for the branded character application. Thus, a user may install the entire branded character application using the microphone device 700.

In another embodiment of the invention, the software code in storage medium 750 is the software code necessary to present the branded character on the display of the personal computer, in connection with the branded character voice interactive application. For example, a branded character application, with a professional football player as the branded character, is resident on a personal computer. A microphone device 700 is. connected to the personal computer, where the microphone device 700 is in the shape of Spider-man™. The software code from the storage medium 750 in the microphone device 700 is loaded on the personal computer and instructs the branded character application to use the software code to present Spider-man™on the display of the computer. Thus, multiple users could interact with a branded character application, with each user having a unique branded character.

Microphone device 700, including microphone 710, cord 720, interface 730, speaker 740, and storage medium 750 may be conventional components known in the art. Microphone device 700 may be a branded character formed of plastic or other material commonly used in action figures and the like.

According an embodiment of the invention, a video camera device is used to allow a user to manipulate a voice activated video instant messaging or the like. It is understood that the video may also include accompanying audio as well as images. The video camera, such as in the form of a standard webcam, may be used to record video images. According to an embodiment of the invention, the video camera may be used in connection with the microphone device 700 to create a video, with the video camera recording the images and the microphone recording the audio sound. Alternatively, the video camera may be incorporated into microphone device 700 to create the video. Further, the video camera and microphone may be any standard equipment used with a computer, whether as part of that computer, or added components.

Using the video camera and the instant messaging of the present invention, a user can transmit and view on video which friends are online and communicate with them in near-real time via the video. The video may also be stored for later viewing or transmitting. Using the voice activated application, such as a branded character application, a user can request a character or characters (e.g., Spider-man™, Ronald McDonald, etc.) to record, send, and playback messages.

A webcam and microphone allows live or near-live images and audio to be shared while online. The software can be completely controlled by voice commands spoken to animated characters, such as Ronald McDonald™, which act as a host (interface) for the software. According to an embodiment of the invention, both the ‘sending’ user and the ‘receiving’ user have the necessary hardware and software installed just described above. Alternatively, a ‘sending’ user has the necessary hardware and software installed. A message sent by this ‘sending’ user includes a prompt to the ‘receiving’ user to obtain the necessary software, such as through a download from an appropriate website or by including the necessary software. The message also may prompt the ‘receiving’ user to identify the necessary hardware for properly viewing the message and accompanying video.

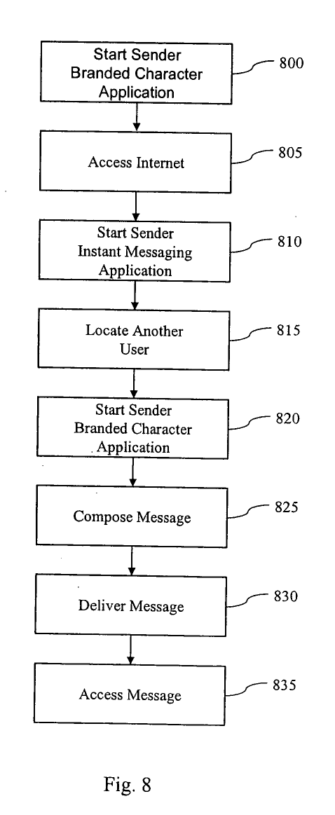

FIG. 8 is a flowchart illustrating a process for a speech activated voice and video instant messaging service according to an embodiment of the invention. At step 800, a sender branded character application is activated. At step 805, the internet is accessed, and an instant messaging application is accessed at step 810. Another user is located at step 815. At step 820, the message is composed. The message is sent at step 825, and delivered to another user at step 830. The message is accessed by another user at step 835. The process will now be described in greater detail below. It is understood that the process as described in FIG. 8 may have additional steps, may omit steps, may be performed in a different order, or some combination thereof.

At step 800, a sender branded character application is activated. The sender branded character application, as described above, may present a branded character on the display for the user. The user then commands the branded character, using voice and speech recognition. The character can be commanded using a keyboard, mouse, or other inputs as well.

At step 805, the internet is accessed, and an instant messaging application is accessed at step 810. As described above, the branded character application may be commanded to access the internet, or other type of network that permits appropriate communication, such as an intranet. Further, the branded character application may be commanded to access the instant messaging application. The branded character application may activate an icon located on the user's desktop to start the instant messaging application.

Another user is located at step 815. The user may command the branded character to look for one or more users that are accessing the instant messaging application. According to an embodiment of the invention, both users must be logged onto the internet and/or the instant messaging application.

At step 820, the message is composed. The branded character may create a message on the user's desktop. For example, the user, which in this example is a sender, asks the branded character to send a message to a given friend. The branded character says “OK” and activates the video camera and microphone, such as that in microphone device 700, to record the sender's image and message.

The message is sent subsequently to step 825, and delivered at step 830. The branded character may then ask the sender if the message should be delivered immediately. If the user responds “yes,” then the message is delivered to the designated user, or receiver. This allows the video to be transmitted in virtual real-time. The voice and video message are received at the receiver's computer. According to an embodiment of the invention, the branded character, through the branded character application on the receiver's computer, announces that the message has been received. The branded character may ask the receiver if the message should be viewed now.

The message is accessed at 835. According to an embodiment of the invention, if the receiver desires, the branded character will open the message and play the video portion. Alternatively, the message and/or accompanying video may be saved for viewing at a later time. Video messages may be stored to the user's local computer for later viewing.

It is understood that the use of voice and video instant messaging with the present branded character application is not limited to a personal computer. Rather, cell telephone, personal digital assistants (PDA), video camera's with wireless transmission and reception capabilities and the like may be used.

The animation of the characters can be animated over the web for special events or holidays. In addition, voiceprints of all users on the system can be saved for security verification. Parental controls will allow parents to save clips and reference logs files for later viewing.

As discussed above, the software features, tasks and promotions may all be updated. In this regard, the appearance of the product character can be controlled by the computer clock and calendar enabling the product character to appear on particular days or at particular times. Through web-linked updates coordinated with the calendar and clock of an electronic device, the business is able to time the appearance of the promotion and/or the product character to correspond with advertised events such as the announcement of a new product, upgrades to existing products, limited time offers, and other time-sensitive promotions. The consumer user can then be periodically reminded as the expiration of the offer draws near.

In an alternative embodiment, the product character is presented in a game which utilizes the recognized voice command of the consumer user. The game is played through interactions between the product character and the consumer user to advance the game.

In another alternative embodiment, the product character interacts with the recognized voice command of the consumer user to provide promotion instruction as product information or as a general educational lesson. In one embodiment, general educational instruction is made available to consumers in a series of lessons offered on a periodic basis such as every week, whenever a product update occurs, or at any other time period. The promotion instruction can be distributed to the consumer user in physical form such as CD, Mini-Disc, DVD, or other transportable media, or in electronic form, such as a web link, or wireless link.

The product character, in one embodiment, presents a language lesson. The product character reads a word, a phrase or a sentence to the consumer user prompting the consumer user to recite the words back. The voice-recognition software detects if the consumer user recites the word, phrase or sentence correctly and enables the product character to respond accordingly, such as “Congratulations Suzy” or “Let's try that again.” Successful attempts by the consumer user in the promotion instruction software advances the consumer user through the current lesson and through other subsequent lessons provided to the consumer user. In one embodiment, prizes such as sweepstakes entries or any other suitable incentives are provided to the consumer user upon installing the software, completing a lesson, or accomplishing any suitable task to reward the consumer user.

Similarly, the product character may be used in one embodiment to present product information. The product information may include background information, general operating instruction, specific uses of the product, advantages of the product, technical specifications or any other information the business desires to include about the product. The present invention contemplates prompting recognized voice commands of the consumer user to provide correct responses to questions asked by the product character or to acknowledge satisfaction with an answer provided by the product character. Progressive interaction between the product character and the consumer user advances the consumer user through the promotion instruction software.

In this regard, the voice interactive application may act to pique the consumer user's interest, thus compelling the consumer user to continue to interact with the promotional software. This interaction with the product character can function to build brand recognition and goodwill as the electronic display acts as a billboard personalized to the consumer user where the product character is presented continually in both visual and audio formats. Continued consumer user interaction with the voice interactive product character will invariably encourage purchases of the product at a substantially low cost per impression.

In one embodiment of the invention, the interactive promotional software includes a voice interactive screen saver application. The voice interactive screen saver provides a unique combination of screen saver and voice verification technology for improved business marketing, promotional and/or advertising purposes. The screen saver is a computer software program that controls the display of an image or series of images on a computer monitor when the computer is on but is idle. The screen saver is typically activated after a predetermined time beginning from a last action performed by the consumer user. It should be appreciated that the duration of the predetermined time can be set to include any suitable and desirable time period depending on the application and/or the needs of the consumer user.

Once activated, the screen saver can function until interrupted by a user input in the form of a keyboard input, movement of the computer mouse, or any other input suitable to interrupt the screen saver mode. Upon interruption by the user, the screen saver mode ends and the working environment or desktop is displayed. Alternatively, the screen saver acts as a tool for privacy prompting the user for a password or voice input before returning what was displayed on the computer monitor prior to activation of the screen saver to the display. In one embodiment, the entered password is compared to a stored password typically based on the preference of the consumer user. If the password is authenticated, the screen saver shuts down; otherwise, it continues to prompt for the correct password. If the prompt does not detect any user input, then it reverts to the screen saver mode.

Alternatively, the voice verification technology of the present invention provides a unique authentication tool for integration with the computer operable screen saver. In one embodiment, the consumer user is prompted to speak into the user interface such as a microphone operably connected to software which is processed by the software and is compared to the voice of the consumer user previously recorded and stored in the electronic device. As such, the screen saver can be utilized as a multi-media consumer user experience which, when interrupted, employs voice input recognition for authentication purposes. It should be appreciated that multiple voice recordings can be stored for authentication and activating the multi-media presentation customized to individual consumer users.

The voice activated screen saver can be modified in a number of suitable ways depending on the application and in order to make the screen saver more attractive for use by the end user. For example, if voice authentication is successful and/or if it fails, the screen saver can be modified to prompt the consumer user with a message, such as text, image, voice and/or the like, acknowledging same. If authentication is successful, the consumer user can be prompted, for example, with message, such as a multi-media display including voice, text and/or image output. The multi-media message can indicate that the consumer user has won a sweepstakes and then can further prompt the consumer user to connect to a web-site affiliated with the business in order to obtain the sweepstake's prize. By voice input, the consumer user can then navigate to the web-site.

It should be understood that various changes and modifications to the preferred embodiments of the present invention described herein will be apparent to those skilled in the art. Such changes and modifications can be made without departing from the spirit and scope of the present invention and without diminishing its intended advantages.

1. A method of providing a multi-media interactive promotional experience, said method comprising:
creating a visual component associated with at least one of a concept, product or service being promoted;
providing a computer application having voice and speech recognition capabilities for animating the visual component so that the visual component is responsive to verbal input;
installing the application on a user device adapted to display the interactive visual component and receive verbal input from a user; and
providing instructions to the application via a server in communication with the user device.

2. The method of claim 1, wherein the visual component is selected from the group consisting of a product character, an animated trademark, a corporate logo, a product representation and a product spokesman character.

3. The method of claim 1, further comprising providing a microphone to receive the verbal input from the user, where the microphone has a design associated with the visual component.

4. The method of claim 1, which includes performing tasks in a computer operating environment in response to verbal input by the visual component.

5. The method of claim 4, wherein the task is operating an instant messaging application.

6. An audio-visual interactive promotion comprising:
a visual component associated with at least one of a concept, product or service being promoted;
a software application having voice and speech recognition capabilities for animating said visual component so that said visual component is responsive to verbal input; and
a user device configured to display said interactive visual component.

7. The promotion of claim 6, wherein the visual component is selected from the group consisting of a product character, an animated trademark, a corporate logo, a product representation and a product spokesman character.

8. The promotion of claim 6, wherein a response to verbal input by said visual component includes providing a hyperlink to a web-site.

9. The promotion of claim 6, wherein a response to verbal input by said visual component includes performing at least one software-related task for each recognized voice command of the user.

10. The promotion of claim 9, wherein the software-related task is an instant messaging software program.

11. The promotion of claim 6, wherein the software application is resident on a media located within a microphone connected to said user device, where said microphone receives said verbal input from said user and has a design associated with said visual component.

12. The promotion of claim 6, further comprising a microphone connected to the user device that receives said verbal input from the user, where the microphone has a design associated with the visual component.

13. The promotion of claim 7, wherein the software application receives at least one instruction from a server in communication with said user device.

14. A method of promoting a concept, product or business, said method comprising:
recording a first voice input from a first consumer user;
storing features of the first voice input;
associating the first voice input with a first voice interactive application;
recording a second voice input from a second consumer user;
storing features of the second voice input;
associating the first voice input with a first voice interactive application;
receiving a third voice input;
determining if the third voice input is the same as one of the first voice input and the second voice input;
activating one of the first and the second voice interactive application associated with the received voice input based on the identity of the received third voice input, wherein each of the first and second voice interactive application is based on a theme promoting said concept, product or business; and
displaying to the consumer user a visual component, wherein the visual component is associated with the promoted concept, product, or business, and wherein the visual component is configured to interact with a recognized voice.

15. The method of claim 14, further comprising the step of performing at least one predetermined task associated with the recognized voice command.

16. The method of claim 14, wherein the first voice interactive application is based on a theme promoting the concept, product or business that is different than the concept, product or business that the second first voice interactive application is based on.

17. The method of claim 14, further comprising:
instructing the consumer user through the visual component, wherein the visual component is selected from the group consisting of a product character, an animated trademark, a corporate logo, a product representation and a product spokesman character.

18. The method of claim 17, wherein instructing the consumer user includes providing voice interactive product information.

19. The method of claim 14, further comprising:
customizing the activated one of the first and second voice interactive application to a consumer user.

20. The method according to claim 14, further comprising:
updating the activated one of the first and second voice interactive application.

21. A method for business promotion, comprising the steps of:
providing a device configured to operate a voice interactive application wherein the device is capable of prompting, receiving and processing voice input;
receiving a voice command into the device; and
activating the voice interactive application, wherein the voice interactive application is configured to include interaction with a consumer user through a visual component.

22. The method of business promotion of claim 21, wherein the product character of the voice interactive application performs at least one task associated with a recognized voice command.

23. The method of business promotion of claim 21, wherein the voice interactive application for business promotion includes instructing the consumer user through the product character.

24. The method of business promotion of claim 23, wherein said step of instructing the consumer user includes providing voice interactive product information.

25. The method of business promotion of claim 21, further comprising:
customizing the voice interactive application to the consumer user.

26. The method of business promotion of claim 21, further comprising:
updating the voice interactive application.

27. A computer program product stored in a media that is useable with a device adapted to operate a voice interactive application for business promotion, the computer program product comprising:
computer readable software code means for storing data representing the voice interactive application;
computer readable software code means for executing a plurality of commands to activate the voice interactive application; and
computer readable software code means for running the voice interactive application.
